(19) United States
(12) Patent Application Publication
(10) Pub. No.: US 2012/0242889 A1
(43) Pub. Date: Sep. 27, 2012

(54) IMAGING DEVICE AND MOBILE APPARATUS

(75) Inventors: Katsushi Sumisaki, Osaka (JP); Toshihiko Taniguchi, Nara (JP); Tsunemi Yoshino, Nara (JP); Satoshi Amari, Hyogo (JP)

(73) Assignee: Panasonic Corporation, Osaka (JP)

(21) Appl. No.: 13/514,421

(22) PCT Filed: Jan. 27, 2011
(86) PCT No.: PCT/JP2011/000434

§ 371 Date: Jun. 7, 2012

(30) Foreign Application Priority Data
Feb. 1, 2010 (JP) 2010-020065

(51) Int. Cl. H04N 5/232

(52) U.S. Cl. 348/345; 348/E05.045

(57) ABSTRACT

An imaging device according to the present invention includes a light emitting unit for emitting light toward a photographic subject; a lens movable in a movement region corresponding to a focus region; an imaging element for receiving light through the lens; and a lens control unit for acquiring imaging data photoreceived by the imaging element and for controlling the position of the lens. The lens control unit moves the lens in a stepwise manner in order to acquire imaging data for each field of a focus region. The imaging device further includes a light emission control unit for changing the amount of light emitted from the light emitting unit according to the focus position of the lens in each field.

### TECHNICAL FIELD

The present invention relates to an imaging device including a lens movable in the direction of the optical axis and an imaging element for receiving light through the lens, and to a mobile apparatus including the imaging device.

### BACKGROUND ART

Conventionally, there is known an imaging device including a lens movable in the direction of the optical axis and an imaging element for receiving light through the lens (refer to patent literature 1 for example). Such an imaging device controls the position of the lens in a stepwise manner in order to acquire imaging data for each field of a focus region. The imaging device monitors that the focus evaluated value (e.g. brightness of imaging data) decreases as the lens moves and determines the lens position at the focus evaluated value beginning to fall as a target position.

However, in the imaging device of patent literature 1, the light emitting unit (a light source for auxiliary light of automatic focusing) emits a fixed amount of light regardless of the focus position of the lens for each field when acquiring imaging data for each field of a focus region. Consequently, power from the power supply (e.g. a battery) is undesirably consumed more than necessary.

### CITATION LIST

### Patent Literature

PTL 1 Japanese Patent Unexamined Publication No. H08-186752

### SUMMARY OF THE INVENTION

An imaging device according to the present invention includes a light emitting unit for emitting light toward a photographic subject; a lens movable in a movement region corresponding to a focus region; an imaging element for receiving light through the lens; and a lens control unit for acquiring imaging data photoreceived by the imaging element and for controlling the position of the lens. The lens control unit moves the lens in a stepwise manner in order to acquire imaging data for each field of a focus region. The imaging device further includes a light emission control unit for changing the amount of light emitted from the light emitting unit according to the focus position of the lens in each field.

With an imaging device according to the present invention, the light emission control unit changes the amount of light emitted from the light emitting unit according to the focus position of the lens in each field when the lens control unit acquires imaging data for each field of the focus region. This allows increasing the amount of light emitted from the light emitting unit from the near point toward the far point of the focus position of the lens.

### BRIEF DESCRIPTION OF DRAWINGS

FIG. 1A is a perspective view of the entire mobile apparatus according to an exemplary embodiment of the present invention.

FIG. 1B is a perspective view of the entire mobile apparatus according to the exemplary embodiment of the present invention, viewed from a different direction.

FIG. 2 is a general view of the mobile apparatus, showing its imaging device according to the exemplary embodiment of the present invention according to the exemplary embodiment of the present invention.

FIG. 3 is a circuit diagram of the mobile apparatus, showing its light emitting element drive device according to the exemplary embodiment of the present invention.

FIG. 4A is a correlation diagram between time and a lens position of the imaging device.

FIG. 4B is a correlation diagram between time and a focus evaluated value of the imaging device according to the exemplary embodiment of the present invention.

FIG. 4C is a correlation diagram between time and a set value of a current flowing through the light emitting unit, of the imaging device according to the exemplary embodiment of the present invention.

FIG. 4D is a correlation diagram between time and the amount of light emitted from the light emitting unit, of the imaging device according to the exemplary embodiment of the present invention.

### DESCRIPTION OF EMBODIMENT

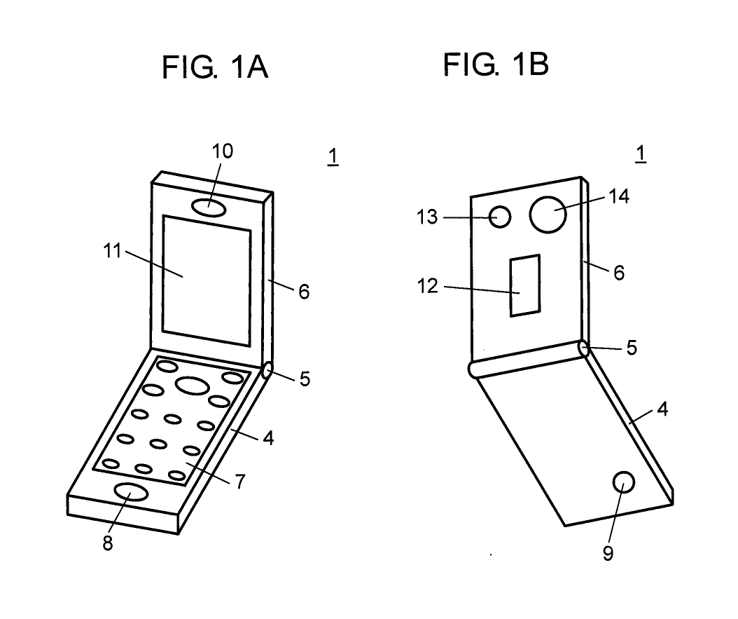

Hereinafter, a description is made of an imaging device and a mobile apparatus according to an exemplary embodiment of the present invention, in reference to FIGS. 1A through 4D.

As shown in FIG. 1A through 3, mobile apparatus 1 according to the exemplary embodiment is a mobile telephone incorporating a digital camera function and an LED flash function, namely including imaging device 2 and light emitting element drive device 3. Further, mobile apparatus (hereinafter also referred to as a mobile telephone) 1 includes first body 4; and second body 6 foldable first body 4 through hinge mechanism 5.

First body 4 includes operation key unit 7 composed of such as numeric keys, on the inner surface of mobile telephone 1 (in a folded state), for receiving input for operating mobile telephone 1; and microphone 8 for receiving input of transmission voice. First body 4 further includes sounder 9 for providing notification of such as incoming calls, on the outer surface of mobile telephone 1 (in a folded state).

Second body 6 includes speaker 10 for outputting reception voice, on the inner surface of mobile telephone 1 (in a folded state); and first display 11 for displaying characters and images. Second body 6 further includes second display 12 for displaying characters and images (similarly to first display 11), on the outer surface of mobile telephone 1 (in a folded state); light emitting unit (light emitting element) 13 for emitting light; and optical system 14 for collecting light (e.g. light from light emitting element 13 or the sun) reflected on a photographic subject.

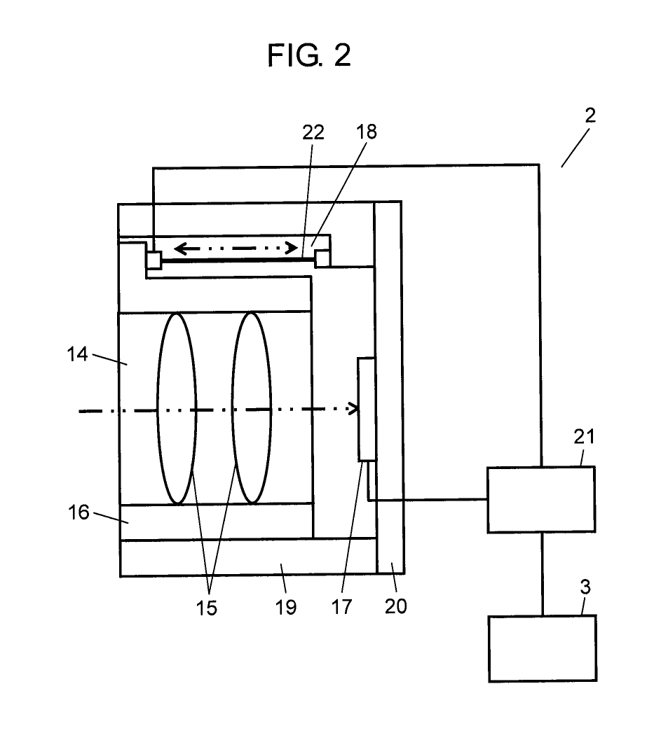

Imaging device 2 has optical system 14 composed of multiple lenses 15. Imaging device 2 includes lens barrel 16 movable in the direction (the single directional arrow in FIG. 2) of the optical axis along with lenses 15 contained in lens barrel 16; imaging element (CMOS or CCD image sensor) 17 receiving light through lenses 15; and moving unit 18 for moving lenses 15 through lens barrel 16.

Imaging device 2 includes case 19 for containing lens barrel 16; and substrate 20 placing imaging element 17 thereon and fixed to case 19. Imaging device 2 further includes lens control unit 21 for acquiring imaging data photoreceived by imaging element 17 and for controlling the position of lenses 15.

Lenses 15 move in a movement region corresponding to a focus region of imaging device 2 integrally with lens barrel 16. In this exemplary embodiment, two lenses 15 are provided, but not limited to such a case; one, or three or more may be provided.

In this exemplary embodiment, moving unit 18 is actuator 22 made of a shape-memory alloy (SMA) that is deformed by a heat quantity such as electric power (current and voltage) supplied, which makes the entire unit be deformed (expand and contract) in the direction of the optical axis (the bidirectional arrow in FIG. 2) to move lenses 15. Moving unit 18 is not limited to actuator 22 made of a shape-memory alloy, but may be any component as long as it is movable in the direction of the optical axis.

Lens control unit 21 controls the deformation amount of actuator 22 to move lenses 15 to a position corresponding to each field in a stepwise manner in order to acquire imaging data for each field of a focus region. At this moment, lens control unit 21 controls the position of lenses 15 so that lenses 15 become apart from imaging element 17 in order that the focus position of lenses 15 moves from the near point toward the far point.

Then, lens control unit 21 acquires imaging data for each field of a focus region from the near point and integrates imaging data only within a given range out of two-dimensional imaging data acquired for each field. Next, lens control unit 21 records a value determined by the integration as a focus evaluated value (e.g. brightness of imaging data). Further, lens control unit 21 monitors that the focus evaluated value decreases to determine (calculate) the position of lenses 15 immediately before the focus evaluated value begins to fall as a target position; moves lenses 15 to the target position; and stops lenses 15.

Light emitting element drive device 3 includes (besides above-described light emitting element 13) drive unit 23 for driving light emitting element 13; electricity storage element 24 capable of storing electric power; and battery power supply 25 capable of supplying electric power to drive unit 23 and electricity storage element 24. Light emitting element drive device 3 further includes (besides light emitting element 13) light emission control unit 26 for controlling the entire device; constant current circuit 27 for regulating a current flowing through light emitting element 13 to a set value; and constant voltage circuit 28 for regulating the value of voltage supplied from battery power supply 25 to a set value.

In this exemplary embodiment, light emitting element 13 is a (white) LED, and drive unit 23 includes inverter (NOT gate) 29; and first through third switch units (CMOS) 30 through 32. Electricity storage element 24 is an electric double-layer capacitor, and battery power supply 25 is a Li-ion secondary battery and doubles as a power supply for imaging device 2 (not only for light emitting element drive device 3).

Drive unit 23 is switchable between a storing state and a discharging state. The storing state is a state in which electricity storage element 24 and light emitting element 13 are parallel-connected to battery power supply 25 to make electricity storage element 24 store electric power supplied from battery power supply 25. The discharging state is a state in which battery power supply 25, electricity storage element 24, and light emitting element 13 are series-connected (i.e. electricity storage element 24 and light emitting element 13 are series-connected to battery power supply 25) to supply electric power from battery power supply 25 and the electric power stored in electricity storage element 24 to light emitting element 13.

Light emission control unit 26 controls drive unit 23 in order to switch between the storing state and the discharging state. Further, light emission control unit 26 controls constant current circuit 27 in order to change the amount of light emitted from light emitting element 13. Concretely, light emission control unit 26 controls a current value set in constant current circuit 27 according to the focus position of lenses 15 in each field. More specifically, light emission control unit 26 controls a current value set in constant current circuit 27 so as to increase the amount of light emitted from light emitting element 13 from the near point toward the far point of the focus position of lenses 15.

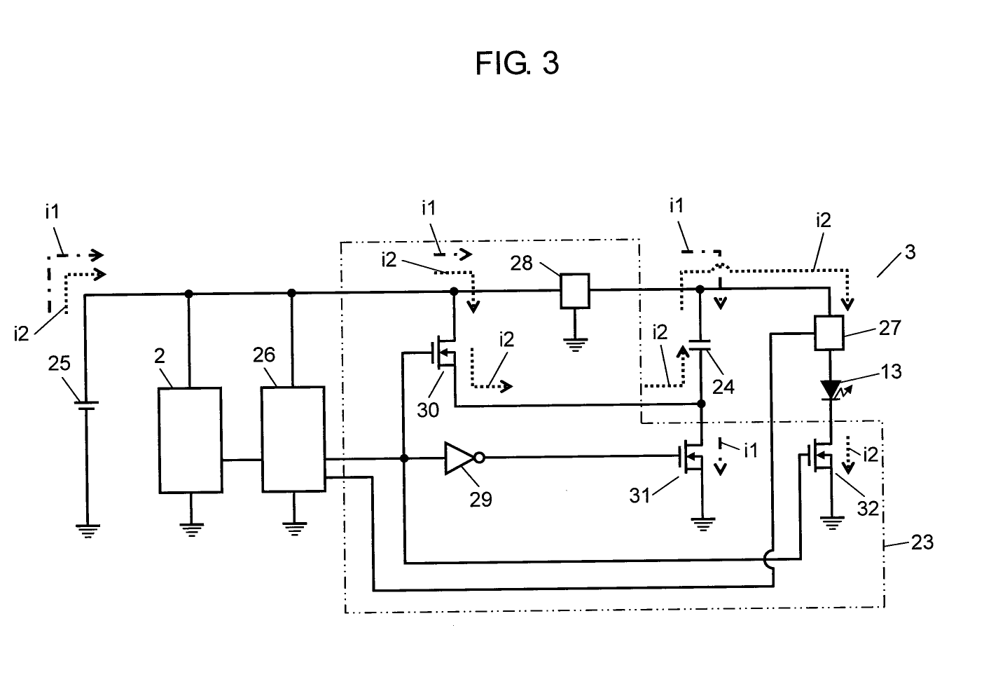

Imaging device 2 and mobile telephone 1 according to the exemplary embodiment are configured as above. Next, a description is made of operation of light emitting element drive device 3 according to the exemplary embodiment in reference to FIG. 3.

First, in the storing state, when light emission control unit 26 outputs an L signal, it is applied to the input of the gates of first and third CMOSes 30 and 32, which are thus turned off (open). Meanwhile, when the L signal is applied to the input of inverter 29, an H signal is applied to the gate of the input of second CMOS 31, which is thus turned on (close).

Consequently, current i1 flows from battery power supply 25 through the closed loop of constant voltage circuit 28, electricity storage element 24, and second CMOS 31, which makes electricity storage element 24 store electric power supplied from battery power supply 25. At this moment, the voltage applied to electricity storage element 24 is decreased from 3.6 V (electric power supplied from battery power supply 25) to 3.0 V by constant voltage circuit 28, and thus electricity storage element 24 can store electric power of 3.0 V. Here, although voltage is applied to light emitting element 13 as well, light emitting element 13 does not emit light since third CMOS 32 is off (open).

In the discharging state, when light emission control unit 26 outputs an H signal to activate the circuit, the H signal is applied to the input of the gates of first and third CMOS 30 and 32, which are thus turned on (close). Meanwhile, the H signal is applied to the input of inverter 29 to make an L signal be applied to the input of the gate of second CMOS 31, which is thus turned off (open).

Consequently, the positive-voltage side of battery power supply 25 is connected to the negative-voltage side of electricity storage element 24, and thus current i2 flows from battery power supply 25 through the closed loop of first CMOS 30, electricity storage element 24, constant current circuit 27, light emitting element 13, and third CMOS 32, which makes battery power supply 25 and electricity storage element 24 supply electric power to light emitting element 13. At this moment, the sum of a voltage value of 3.6 V of electric power supplied from battery power supply 25 and a voltage value of 3.0 V of electric power discharged from electricity storage element 24 is higher than a voltage value of 4.0 V of electric power with which light emitting element 13 emits light.

Hence, a voltage high enough to emit light is applied to light emitting element 13, and thus a current value at a given level set to constant current circuit 27 flows through light emitting element 13, which thus emits light. At this moment, light emission control unit 26 performs control (change) so that light emitting element 13 emits a larger amount of light, namely the current value set to constant current circuit 27 becomes greater, from the near point toward the far point of the focus position of lenses 15.

Light emitting element 13 works not only as a light source for auxiliary light when acquiring imaging data for each field of a focus region but also as a light source for flash light when imaging. When light emitting element 13 functions as a light source for flash light, light emission control unit 26 performs control so as to maximize a current value set to constant current circuit 27.

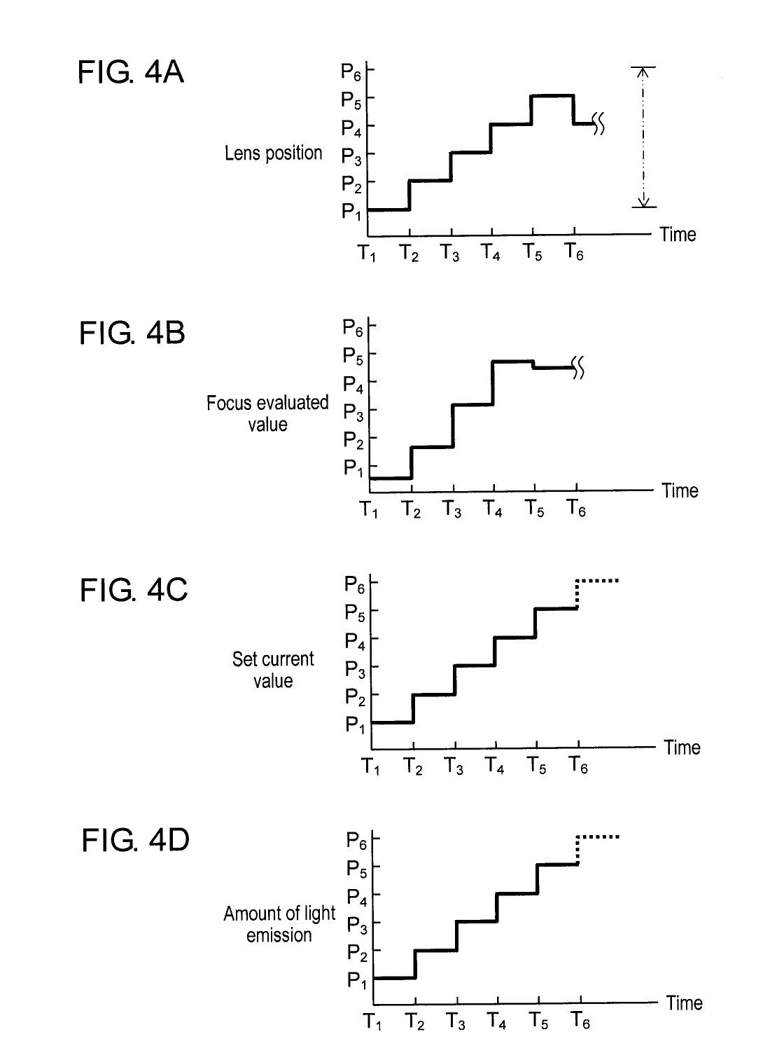

Operation of light emitting element drive device 3 according to the exemplary embodiment is described as above. Next, a description is made of a manner of automatic focusing in imaging device 2 in reference to FIGS. 2, and 4A through 4D.

First, lens control unit 21 controls the deformation amount of actuator 22 to move lenses 15 so as to become apart from imaging element 17. In this exemplary embodiment, the focus region has six fields, namely six lens positions where lenses 15 stop, but not limited to the case.

Then, lenses 15 sequentially move from lens position P1 corresponding to the field at the nearest point within a movement region (indicated by the bidirectional arrows of the two-dot chain line in FIG. 4A) corresponding to the focus region of imaging device 2. Concretely, lenses 15 move in a stepwise manner while stopping for a given time (≈Tₙ−Tₙ₋₁) at each lens position (Pn) corresponding to each field in the focus region.

At this moment, lens control unit 21 repeats recording focus evaluated values according to imaging data acquired for each field (each lens position Pn) in the focus region. Then, as shown in FIG. 4B, lens control unit 21 monitors lens position (P5) when the focus evaluated value decreases to determine lens position (P4) of lenses 15 immediately before the focus evaluated value begins to fall as a target position; moves lenses 15 to the target position (P4); and stops lenses 15.

As shown in FIG. 4C, light emission control unit 26 performs control so that the current value set to constant current circuit 27 becomes greater from the near point toward the far point of the focus position of lenses 15. Consequently, as shown in FIG. 4D, the amount of light emitted from light emitting element 13 increases from the near point toward the far point of the focus position of lenses 15. The broken lines in FIGS. 4C and 4D indicate a current value set to constant current circuit 27 and the amount of light emitted from light emitting element 13 in the case where lenses 15 move to lens position (P6) where the focus position of lenses 15 is the farthest point.

From all of the above, with imaging device 2 and mobile apparatus 1 according to the exemplary embodiment, when lens control unit 21 acquires imaging data for each field of the focus region, light emission control unit 26 changes the amount of light emitted from light emitting element 13 according to the focus position of lenses 15 in each field. This allows light emission control unit 26 to increase the amount of light emitted from light emitting element 13 from the near point toward the far point of the focus position of lenses 15, which reduces electric power consumption when acquiring imaging data for each field of the focus region.

With imaging device 2 and mobile apparatus 1 according to the exemplary embodiment, lens control unit 21 controls the position of lenses 15 so that the focus position of lenses 15 moves from the near point toward the far point. This effectively reduces electric power consumption when lens control lens control unit 21 acquires imaging data for each field of the focus region.

The light emitting element drive device and the mobile apparatus according to the present invention are not limited to the above-described exemplary embodiment, but obviously various types of modifications may be added within a scope that does not deviate from the gist of the present invention.

As described above, an imaging device according to the present invention includes a light emitting unit for emitting light toward a photographic subject; a lens movable in a movement region corresponding to a focus region; an imaging element for receiving light through the lens; and a lens control unit for acquiring imaging data photoreceived by the imaging element and for controlling the position of the lens. The lens control unit moves the lens in a stepwise manner in order to acquire imaging data for each field of a focus region. The imaging device includes a light emission control unit for changing the amount of light emitted from the light emitting unit according to the focus position of the lens in each field.

With an imaging device according to the present invention, the light emission control unit changes the amount of light emitted from the light emitting unit according to the focus position of the lens for each field when the lens control unit acquires imaging data for each field of the focus region. This allows the light emission control unit to increase the amount of light emitted from the light emitting unit from the near point toward the far point of the focus position of the lens.

With an imaging device according to the present invention, the lens control unit may control the lens position so that the focus position of the lens moves from the near point toward the far point. With an imaging device thus configured, the lens control unit controls the lens position so that the focus position of the lens moves from the near point toward the far point. This effectively reduces electric power consumption when the lens control unit acquires imaging data for each field of the focus region.

A mobile apparatus according to the present invention includes the above-described imaging device.

### INDUSTRIAL APPLICABILITY

An imaging device and a mobile apparatus according to the present invention are applicable to those that require reducing electric power consumption when acquiring imaging data for each field of a focus region.

### REFERENCE MARKS IN THE DRAWINGS

Mobile apparatus (mobile telephone)
Imaging device
Light emitting element drive device
First body
Hinge mechanism
Second body
Operation key unit
Microphone
Sounder
Speaker
First display
Second display
Light emitting unit (light emitting element)
Optical system
Lens
Lens barrel
Imaging element
18 Moving unit
19 Case
20 Substrate
21 Lens control unit
22 Actuator
23 Drive unit
24 Electricity storage element
25 Battery power supply
26 Light emission control unit
27 Constant current circuit
28 Constant voltage circuit
29 Inverter (NOT gate)
30 First CMOS
31 Second CMOS
32 Third CMOS

1. An imaging device comprising:
a light emitting unit for emitting light toward a photographic subject;
a lens movable in a movement region corresponding to a focus region;
an imaging element for receiving light through the lens; and
a lens control unit for acquiring imaging data photoreceived by the imaging element and controlling a position of the lens,
wherein the lens control unit moves the lens in a stepwise manner in order to acquire the imaging data for each field of the focus region, and the imaging device further includes a light emission control unit for changing an amount of light emitted from the light emitting unit according to a focus position of the lens in each field.

2. The imaging device of claim 1, wherein the lens control unit controls a position of the lens so that a focus position of the lens moves from a near point toward a far point.

3. A mobile apparatus including the imaging device of one of claim 1.

4. A mobile apparatus including the imaging device of claim 2.
